(19) United States
(12) Patent Application Publication
(10) Pub. No.: US 2026/0162261 A1
(43) Pub. Date: Jun. 11, 2026

(54) COMPUTER-AIDED SYSTEM AND METHOD FOR CLASSIFICATION OF BREAST DENSITY IN MAMMOGRAPHIC IMAGES

(71) Applicant: University of Louisville Research Foundation, Inc., Louisville, KY (US)

(72) Inventors: Ayman S. El-Baz, Louisville, KY (US); Ibrahim S. Abdelhalim, Louisville, KY (US); Sohail G. Contractor, Prospect, KY (US)

(21) Appl. No.: 19/415,363

(22) Filed: Dec. 10, 2025

Related U.S. Application Data
(60) Provisional application No. 63/730,624, filed on Dec. 11, 2024.

(51) Int. Cl. G06T 7/00

(52) U.S. Cl. CPC G06T 7/0012; G06T 2207/20081; G06T 2207/20084; G06T 2207/20104; G06T 2207/30068

(57) ABSTRACT

A non-invasive computer-aided system and method for classification of breast density in mammographic images includes receiving medical images of a subject breast captured from two different views, extracting regions of interest including a breast lesion and surrounding tissue, using a convoluted neural network to extract local features indicative of the density of tissue surrounding the breast lesion, and classifying the breast using a transformer-based classifier.

### CROSS-REFERENCE TO RELATED APPLICATION

This application claims the benefit of priority to U.S. provisional patent application Ser. No. 63/730,624 filed Dec. 11, 2024, for COMPUTER-AIDED SYSTEM AND METHOD FOR CLASSIFICATION OF BREAST DENSITY IN MAMMOGRAPHIC IMAGES, incorporated herein by reference.

### FIELD OF THE INVENTION

A non-invasive computer-aided system and method for classification of breast density in mammographic images includes receiving medical images of a subject breast captured from two different views, extracting regions of interest including a breast lesion and surrounding tissue, using a convoluted neural network to extract local features indicative of the density of tissue surrounding the breast lesion, and classifying the breast using a transformer-based classifier.

### BACKGROUND OF THE INVENTION

Breast density (BD) is a significant risk factor for breast cancer, as it represents the ratio of fibroglandular tissue (FT) to adipose tissue (AT) in the breast. The American College of Radiology's Breast Imaging Reporting and Data System (BI-RADS) categorizes breast tissue into four categories based on the degree of X-ray absorption and mammographic density. These categories are: A (fatty), B (scattered density), C (heterogeneously dense), and D (extremely dense). Exemplary mammography images of each category are shown in FIG. 1 (left-to-right, categories A, B, C, and D).

Deep Learning (DL) methods have shown to outperform traditional Machine Learning (ML) techniques in extracting features from diverse datasets. Numerous studies have employed DL-based models for categorizing BD into the four BI-RADS levels. However, these methods either focus on utilizing Regions of Interest (ROIs) while overlooking the complementary information from the craniocaudal (CC) and mediolateral oblique (MLO) views, or they utilize both views without initially extracting pertinent information, such as breast cancer lesions. Additionally, some methods merely perform binary classification of breast cancer as benign or malignant, neglecting the detailed categorization based on the four BI-RADS categories. A need exists for automated, accurate classification of mammographic images into BI-RADS categories to assess breast cancer risk more reliably than current automated methods.

### SUMMARY

The present invention addresses these needs by introducing a novel vision transformer-based system. The system and method of the present invention employ a DL approach, with a Transformer-based Density Contextual Module (TDCM) to categorize breast cancer into one of four groups (such as, the four BI-RADS categories). The system combines the benefits of a convoluted neural network (CNN) based model, which focuses on local information, with a TDCM, which regularizes the focus and directs more attention to global information, such as the tissue associated with breast masses. The present invention includes a CNN-based model as the system architecture and performs ROI cropping for each BI-RADS density level, which minimizes distractions and enables the CNN-based model to extract essential radiomic features from each view. The features from each perspective are integrated through a concatenation layer which combines both CC and MLO views. The present invention employs an attention mechanism to enhance the modeling of low-level features and implements a teacher-student strategy by introducing a distillation token to the TDCM to enhance the framework's understanding of breast cancer density characteristics (such as, local radiomics). The TDCM introduces K learnable class embeddings and jointly processes these class embeddings and patch embeddings through self-attention to generate contextual logits. The TDCM also includes the distillation token which interacts with other embeddings to further regularize the system to understand the local features associated with breast cancer lesions.

In one embodiment, the present invention includes a computer-aided method for classification of mammographic images comprising receiving a plurality of medical images of a subject breast, wherein the plurality of medical images includes medical images captured from two different views; extracting from each of the plurality of medical images at least one region of interest (ROI), the ROI including a breast lesion and surrounding tissue; extracting from each of the at least one ROI, using a convoluted neural network, local features indicative of the density of tissue surrounding the breast lesion; and classifying, using a transformer-based machine-learning classifier, the subject breast as one of four categories, wherein the classifier receives as input extracted features originating from the medical images captured from two different views. In some embodiments, extracting local features indicative of the density of tissue surrounding the breast lesion, further includes extracting local features from each of the two different views. In further embodiments, the features extracted from each of the two different views are concatenated prior to being received as input into the classifier. In certain embodiments, the two different views are the craniocaudal view and the mediolateral oblique view. In some embodiments, the categories are fatty, scattered density, heterogeneously dense, and extremely dense. In further embodiments, the convoluted neural network is selected from the group consisting of ResNet-18, EfficientNet, MobileNetV3, and Swin Transformer. In certain embodiments, the convoluted neural network comprises ResNet-18. In some embodiments, the classifier includes a transformer encoder. In further embodiments, the classifier reshapes the extracted features into a plurality of patch embeddings. In certain embodiments, the transformer encoder adds a plurality of learnable position embeddings to the plurality of patch embeddings prior to classification of the subject breast. In some embodiments, the classifier introduces a plurality of learnable class embeddings which are processed by the transformer encoder. In further embodiments, the transformer encoder includes a plurality of layers, each layer including a multi-headed self-attention block followed by a point-wise Multi-Layer Perceptron block, with layer normalization applied before and residual connections added after each block. In certain embodiments the classifier further includes a distillation token trained, at least in part, based on inferencing output from a computer vision description using a teacher-student method.

In another embodiment, the present invention includes a computer-aided system for classification of mammographic images, the system comprising at least one non-transitory computer readable storage medium having computer program instructions stored thereon; and at least one processor configured to execute the computer program instructions causing the processor to perform the previously recited operations.

It will be appreciated that the various systems and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 depicts a series of exemplary MLO view mammography images showing each of the BI-RADS categories. Exemplary images are, left-to-right, A (fatty), B (scattered density), C (heterogeneously dense) and D (extremely dense).

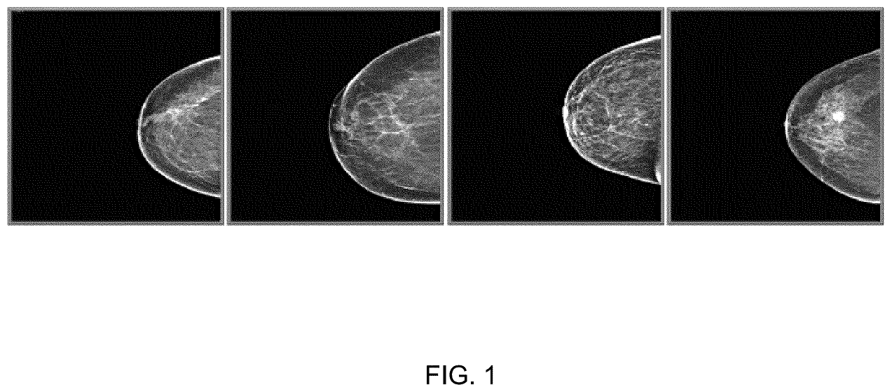

FIG. 2 depicts a schematic illustration of a computer-aided system using multi-view mammographic images to classify breast cancer lesions into categories.

FIG. 3 depicts a pair of exemplary mammography images in column (a), with bounding boxes defined around breast lesions. Images in column (b) are expanded views of the ROI within each bounding box after extraction.

FIG. 4 depicts (top row) three exemplary ROI from mammographic images and (bottom row) corresponding DAISY features of each ROI.

### DETAILED DESCRIPTION OF THE PREFERRED EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter. As used herein, the term “about,” when referring to a value or to an amount is meant to encompass variations of +10% of the most precise digit in the value or amount (e.g., “about 1” refers to 0.9 to 1.1, “about 1.1” refers to 1.09 to 1.11, etc.). The term “substantially,” when modifying a term associated with a number, has the same meaning as “about” (e.g., “substantially perpendicular” to an element means an orientation with ±10% of 90 degrees with respect to that element).

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

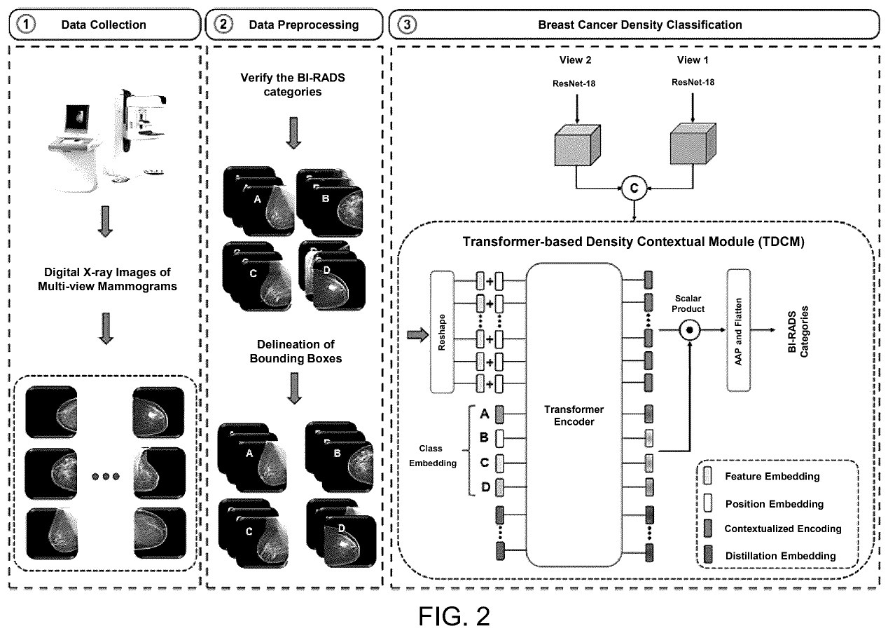

A transformer-based model identifies a risk factor of breast cancer by classifying a subject breast as one of the four BI-RADS categories. This model involves several steps, as summarized in the schematic shown in FIG. 2. These steps begin with the preprocessing of CC and MLO views. The model employs dual 256×256 pixel CC and MLO views and incorporates two branches. Each branch features ResNet-18, a convolutional neural network 18 layers deep, as a backbone for the extraction of salient features from each view. Following this, the extracted features are concatenated and further refined through the TDCM.

### Preprocessing

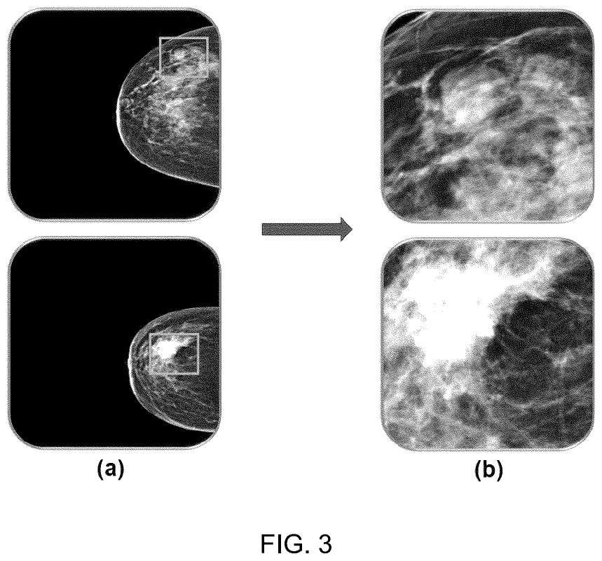

In order to accurately localize breast cancer lesions, a radiologist examined full-size mammograms and delineated bounding boxes around the lesions to extract ROIs. In other embodiments, delineation of bounding boxes need not be performed by a radiologist, as breast lesions are identifiable from the breast images using automated systems. This preprocessing step allows the framework to focus on pertinent ROIs, namely, the breast cancer lesions and surrounding tissue, thereby optimizing weights and enhancing classification by discarding superfluous information. The ROIs were resized to 256×256 pixels. Only images with consensus on BI-RADS categories were included in the initial data set to test the accuracy of this system and method, while conflicting or uncertain cases were excluded. FIG. 3 provides a visual representation of the extraction process for ROIs.

CNN-Based Backbone

The limited availability of breast cancer data currently poses challenges to DL network training. To mitigate this, the present invention utilized fine-tuning, initializing the model with ImageNet-pretrained weights. Among various pre-trained models, ResNet-18 was chosen due to certain advantages its residual connections offer in medical imaging. This approach involves not only utilizing the feature maps from layer 4 of ResNet-18, but also fine-tuning its weights through continued back-propagation. This strategy customizes the ResNet-18 model to the present specific datasets, enhancing its performance in classifying breast cancer within the BI-RADS categories. In other embodiments, other models than ResNet-18 may be used, such as, for example, EfficientNet, MobileNetV3, Swin Transformer, and other models as currently known in the art or later developed.

### Transformer-based Density Contextual Model (TDCM)

The local context of convolutional filters poses challenges in accessing global image details. To mitigate this, the disclosed system includes a hybrid method integrating CNNs for local features and TDCM for global context. TDCM focuses on rich low-level features, essential for discerning breast cancer density nuances amidst visual similarities with surrounding tissues. As illustrated in FIG. 2, TDCM maps patch-level encodings from ResNet-18's layer 4 to class scores, enhancing BC density classification. The patch-level class scores are then converted to logits [symbol] ∈ [symbol] ^{N×K} by adaptive average pooling and flattening. More specifically, an image x∈ [symbol] ^{W×H×3} is encoded using ResNet-18, where W and H represent the width and height of the image, respectively, producing feature maps F₄∈ [symbol] ^{N×C×P×P} (the output of layer 4), with P denoting the patch size (width and height of F₄), N being the number of patches, and C representing the number of channels. Since, as illustrated in FIG. 2, two branches of ResNet-18 are employed for CC and MLO, and the output from ResNet-18 concatenated, which is F₄, the number of channels received by TDCM is H=2×C. These feature maps are reshaped into a sequence of patches x=[x₁, . . . , x_{N}]∈ [symbol] ^{N×P}^{²}^{×H}. Each patch is flattened into a 1D vector and linearly projected to a patch embedding, resulting in a sequence of patch embeddings x=[eₓ_{₁}, . . . , eₓ_{_{N}}]∈ [symbol] ^{N×D}, where e∈ [symbol] ^{D}. To preserve positional information, learnable position embeddings pe=[pe₁, . . . , pe_{N}]∈ [symbol] ^{N×D} are added to the patch sequence, yielding the input sequence of tokens z=x+pe. TDCM introduces a set of K learnable class embeddings ce=[ceₑ, . . . , ce_{K}]∈ [symbol] ^{K×D}, where K is the number of classes (such as, BI-RADS categories). These class embeddings are processed alongside patch encodings z by TDCM's transformer encoder. The concatenation of ce and z is referred to as Ω. The transformer encoder, composed of L layers, operates on the combined sequences Ω, generating contextualized encodings ΩL∈ [symbol] ^{N×D}. Each transformer layer includes a multi-headed self-attention (MSA) block followed by a point-wise MLP block, with layer normalization (LN) applied before and residual connections added after each block:

$$\begin{matrix}{a}_{i - 1} = MSA ( LN ( {Ω}_{i - 1} ) ) + {Ω}_{i - 1} , \\ {Ω}_{i} = MLP ( LN ( {a}_{i - 1} ) ) + {a}_{i - 1} ,\end{matrix}$$

where iϵ{1, . . . , L}. The self-attention mechanism computes queries Q∈ [symbol] ^{N×d}, keys K∈ [symbol] ^{N×d}, and values V∈ [symbol] ^{N×d}, via three point-wise linear layers and then computes self-attention as:

$$MSA ( Q , K , V ) = soft max ( \frac{{QK}^{T}}{\sqrt{d}} ) V$$

The transformer encoder maps the input sequences to a contextualized encoding sequence Ω_{L}=[Ω_{L,1}, . . . , Ω_{L,N}] that contains rich salient information. Next, Ω_{L} is divided into contextualized patch embeddings z_{c} and contextualized class embeddings ce_{c}. Following this, patch-level class logits pl are generated by calculating the scalar product between L2-normalized z_{c}∈ [symbol] ^{N×D} and ce_{c}∈ [symbol] ^{K×D}. These are output by the transformer encoder of TDCM:

$$pl = {z}_{c} {ce}_{c}^{T} .$$

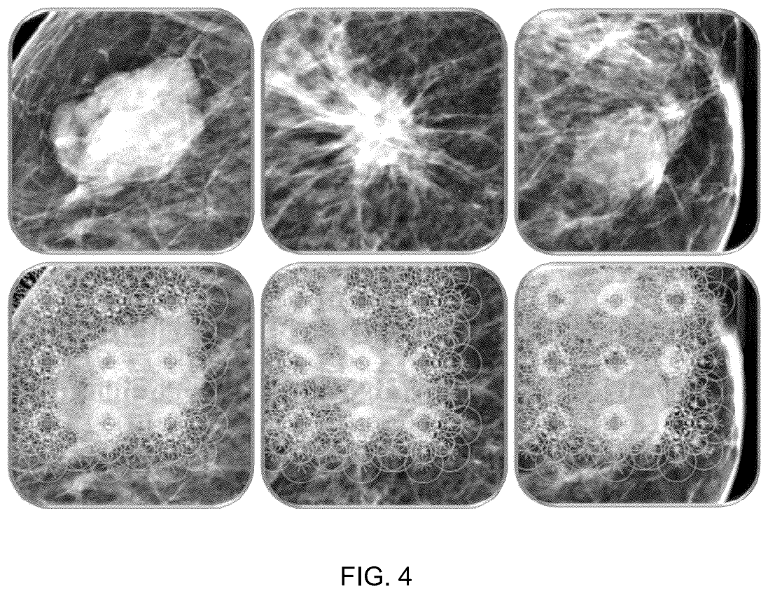

Each pl is then reshaped into p [symbol] ∈ [symbol] ^{K×P×P}. Following this, it undergoes adaptive average pooling and flattening processes to obtain logits [symbol] ∈ [symbol] ^{N×K}. Additionally, a distillation token is introduced to the initial embeddings (patches and class token). This token, similar to the class token, interacts with other embeddings through self-attention and is output by TDCM. Its objective is guided by the distillation component of the loss function, allowing the model to learn from a teacher. In some embodiments, the teacher is the DAISY classical computer vision descriptor. DAISY is a local image descriptor/feature descriptor used in computer vision. Classical descriptors were chosen for their computational efficiency and to prevent TDCM from overlooking local features by biasing the system towards global features exclusively. Empirically, DAISY yielded the best results among other computer vision descriptors. DAISY was selected for its efficient dense wide-baseline matching, resilience to low-quality images, fast computation, and proven effectiveness as shown in FIG. 4. With respect to dense wide-baseline matching, this is shown by alignment of features across varying ROIs even when the features appear at different orientations or scales. FIG. 4 demonstrates such alignment between DAISY features extracted from similar regions across multiple mammograms. With respect to fast computation and proven effectiveness, these qualities are implicit in accurate feature localization with ROIs relevant to breast density around masses, indicating that DAISY reliably identifies key characteristics.

The systems and methods of the present invention provide a computer-aided, automated system for classifying a subject's breast into one of four categories (such as, BI-RADS categories) based on CC and MLO-view mammographic images. This classification system identifies women with dense breast tissue (categorized as BI-RADS C or D), which is associated with a higher risk of breast cancer. Once a subject breast is identified as falling within one of these categories, the next steps in clinical practice include additional imaging beyond standard mammography, risk assessment and counseling, clinical recommendations for additional or more frequent screenings, more aggressive diagnostic procedures, prophylactic measures, or some combination thereof.

### Experiments and Results

The dataset includes 3,020 patients and contains 12,476 mammographic images captured using two HOLOGIC machines. The standard imaging protocol incorporated four views: two CC views and two MLO views with occasional modifications to accommodate specific cases. The distribution of cases is detailed in Table 1. The number of extracted ROIs exceeds the number of images after data preprocessing. This disparity arises from the fact that a single mammographic image may contain multiple lesions, as shown in FIG. 3.

TABLE 1
A summary of the number of cases and images before and
after data preprocessing, including the number of ROIs.

| | Original | Data Preprocessing |
|---|---|---|
| BI-RADS Level | (cases/images) | (cases/images/ROIs) |
| BI-RADS A | 882/3564 | 882/2113/2140 |
| BI-RADS B | 388/1670 | 360/840/969 |
| BI-RADS C | 477/2081 | 424/912/931 |
| BI-RADS D | 273/1241 | 149/323/328 |

The fine-tuning process of ResNet-18 involved 35 epochs using the Adam optimizer (learning rate: 0.0001) and a cosine annealing scheduler. Stratified 3-fold cross-validation was employed on 90% of the data for training, re-serving the remaining 10% for testing the three classifiers that were trained. During testing, the results were obtained either by averaging softmax probabilities (M1) or selecting the most frequently predicted class (M2) across the three trained classifiers. Cross-entropy loss was employed, and L2 loss was applied to distillation embeddings and DAISY features, with both losses contributing equally, each with a weight factor of 0.5, to the overall loss.

As illustrated in Table 2, ResNet-18 achieved the best results in terms of Balanced Accuracy (BA), Sensitivity (SEN), and Specificity (SPE) when compared against other encoders. Several encoders were evaluated, including pure CNNs such as ConvNext (using the tiny version), CNN encoders with self-attention mechanisms like MobileNet 18 (version 3 small), and encoders with pure attention mechanisms such as PVT-B0 117. From the results, it is evident that ResNet-18 benefits from TDCM in understanding global features and from a Teacher-Student strategy to further understand local radiomic features.

TABLE 2
A comparison of the disclosed invention with different encoders
reveals superior results when using the ResNet-18 encoder.

| Encoder | SEN (M1) | SEN (M2) | SPE (M1) | SPE (M2) | BA (M1) | BA (M2) |
|---|---|---|---|---|---|---|
| ConvNext-T | 78.67 ± 1.69 | 78.20 ± 1.69 | 89.94 ± 0.99 | 88.67 ± 0.99 | 73.45 ± 2.84 | 72.90 ± 2.84 |
| MobileNet | 78.20 ± 1.24 | 78.50 ± 1.24 | 88.76 ± 1.78 | 87.52 ± 1.78 | 73.33 ± 2.07 | 73.02 ± 2.07 |
| PVT-B0 | 80.09 ± 0.59 | 80.10 ± 0.59 | 88.12 ± 1.85 | 88.51 ± 1.85 | 72.45 ± 1.25 | 71.01 ± 1.25 |
| ResNet-18 | 84.36 ± 1.95 | 82.94 ± 1.95 | 90.95 ± 1.62 | 89.04 ± 1.62 | 79.09 ± 2.27 | 77.33 ± 2.27 |

BA denotes “balanced accuracy.”

To assess the effectiveness of the disclosed approach, an ablation study was conducted on SEN results for M1/M2, removing certain components of the DL system to understand the contribution of the component to the overall system. As shown in Table 3, using single-view (SV) yielded 60.42%/58.93%. Subsequently, ROIs alone achieved 76.78%/76.30%. Utilizing ResNet-18 on ROIs of CC and MLO views, concatenating them, and passing through the classification layer resulted in 78.20%/77.73%. Integration of TDCM increased performance to 83.41%/82.46%. Furthermore, applying the teacher-student strategy enhanced it to 84.36%/82.94%.

TABLE 3
Ablation study of components of disclosed system

| | | | | | SEN |
|---|---|---|---|---|---|
| SV | ROI | Fusion | TDCM | Dist | (M1/M2) |
| V | | | | | 60.42/58.93 |
| | V | | | | 76.78/76.30 |
| | | V | | | 78.20/77.73 |
| | | V | V | | 83.41/82.46 |
| | | V | V | V | 84.36/82.94 |

The disclosed computer-aided system and method system may be embodied in computer program instructions stored on a non-transitory computer readable storage medium configured to be executed by a computing system. The computing system utilized in conjunction with the computer-aided system described herein will typically include a processor in communication with a memory, and a network interface. Power, ground, clock, and other signals and circuitry are not discussed, but will be generally understood and easily implemented by those ordinarily skilled in the art. The processor, in some embodiments, is at least one microcontroller or general purpose microprocessor that reads its program from memory. The memory, in some embodiments, includes one or more types such as solid-state memory, magnetic memory, optical memory, or other computer-readable, non-transient storage media. In certain embodiments, the memory includes instructions that, when executed by the processor, cause the computing system to perform a certain action. Computing system also preferably includes a network interface connecting the computing system to a data network for electronic communication of data between the computing system and other devices attached to the network. In certain embodiments, the processor includes one or more processors and the memory includes one or more memories. In some embodiments, computing system is defined by one or more physical computing devices as described above. In other embodiments, the computing system may be defined by a virtual system hosted on one or more physical computing devices as described above.

The foregoing detailed description is given primarily for clearness of understanding and no unnecessary limitations are to be understood therefrom for modifications can be made by those skilled in the art upon reading this disclosure and may be made without departing from the spirit of the invention.

1. A computer-aided method for classification of mammographic images comprising:
receiving a plurality of medical images of a subject breast, wherein the plurality of medical images includes medical images captured from two different views;
extracting from each of the plurality of medical images at least one region of interest (ROI), the ROI including a breast lesion and surrounding tissue;
extracting from each of the at least one ROI, using a convoluted neural network, local features indicative of the density of tissue surrounding the breast lesion; and
classifying, using a transformer-based machine-learning classifier, the subject breast as one of four categories, wherein the classifier receives as input extracted features originating from the medical images captured from two different views.

2. The computer-aided method of claim 1, wherein extracting local features indicative of the density of tissue surrounding the breast lesion, further includes extracting local features from each of the two different views.

3. The computer-aided method of claim 2, wherein the features extracted from each of the two different views are concatenated prior to being received as input into the classifier.

4. The computer-aided method of claim 1, wherein the categories are fatty, scattered density, heterogeneously dense, and extremely dense.

5. The computer-aided method of claim 1, wherein the classifier includes a transformer encoder.

6. The computer-aided method of claim 5, wherein the classifier reshapes the extracted features into a plurality of patch embeddings.

7. The computer-aided method of claim 6, wherein the transformer encoder adds a plurality of learnable position embeddings to the plurality of patch embeddings prior to classification of the subject breast.

8. The computer-aided method of claim 7, wherein the classifier introduces a plurality of learnable class embeddings which are processed by the transformer encoder.

9. The computer-aided method of claim 8, wherein the transformer encoder includes a plurality of layers, each layer including a multi-headed self-attention block followed by a point-wise Multi-Layer Perceptron block, with layer normalization applied before and residual connections added after each block.

10. The computer-aided method of claim 9, wherein the classifier further includes a distillation token trained, at least in part, based on inferencing output from a computer vision description using a teacher-student method.

11. A computer-aided system for classification of mammographic images, the system comprising:
at least one non-transitory computer readable storage medium having computer program instructions stored thereon; and
at least one processor configured to execute the computer program instructions causing the processor to perform the following operations:
receiving a plurality of medical images of a subject breast, wherein the plurality of medical images includes medical images captured from two different views;
extracting from the plurality of medical images at least one region of interest (ROI), the at least one ROI including a breast lesion and surrounding tissue;
extracting from each of the at least one ROI, using a convoluted neural network, local features indicative of the density of tissue surrounding the breast lesion; and
classifying, using a transformer-based machine-learning classifier, the subject breast as one of four categories, wherein the classifier receives as input extracted features originating from the medical images captured from two different views.

12. The computer-aided system of claim 11, wherein extracting local features indicative of the density of tissue surrounding the breast lesion, further includes extracting local features from each of the two different views.

13. The computer-aided system of claim 12, wherein the features extracted from each of the two different views are concatenated prior to being received as input into the classifier.

14. The computer-aided system of claim 11, wherein the categories are fatty, scattered density, heterogeneously dense, and extremely dense.

15. The computer-aided system of claim 11, wherein the classifier includes a transformer encoder.

16. The computer-aided system of claim 15, wherein the classifier reshapes the extracted features into a plurality of patch embeddings.

17. The computer-aided system of claim 16, wherein the transformer encoder adds a plurality of learnable position embeddings to the plurality of patch embeddings prior to classification of the subject breast.

18. The computer-aided method of claim 17, wherein the classifier introduces a plurality of learnable class embeddings which are processed by the transformer encoder.

19. The computer-aided method of claim 18, wherein the transformer encoder includes a plurality of layers, each layer including a multi-headed self-attention block followed by a point-wise Multi-Layer Perceptron block, with layer normalization applied before and residual connections added after each block.

20. The computer-aided method of claim 19, wherein the classifier further includes a distillation token trained, at least in part, based on inferencing output from a computer vision description using a teacher-student method.
